(19) United States
(12) Patent Application Publication
(10) Pub. No.: US 2016/0165444 A1
(43) Pub. Date: Jun. 9, 2016

(54) TERMINAL COVER AND WIRELESS COMMUNICATION DEVICE INCLUDING WIRELESS AUTHENTICATION MODULE

(71) Applicant: SAMSUNG ELECTRONICS CO., LTD., Suwon-si (KR)

(72) Inventors: SANGHYO LEE, Yeonsu-gu (KR); SEUNGWON LEE, Yongin-si (KR)

(21) Appl. No.: 14/957,184

(22) Filed: Dec. 2, 2015

(30) Foreign Application Priority Data
Dec. 4, 2014 (KR) 10-2014-0172967

(51) Int. Cl. H04W 12/06; H04B 5/00; H04W 4/00

(52) U.S. Cl. CPC H04W 12/06; H04W 4/008; H04B 5/0087; H04B 5/0031

(57) ABSTRACT

A wireless communication device includes a terminal body including a near field communication (NFC) function and accessories which are attached to the terminal body, and includes a wireless authentication module for an authentication operation through wireless communication with the terminal body. The authentication operation is performed using inductive coupling between an NFC coil of the terminal body and an authentication coil of the wireless authentication module, and in the case that the accessories are attached to the terminal body, the wireless authentication module is disposed so that at least a part of the authentication coil is located outside the NFC coil.

### CROSS-REFERENCE TO RELATED APPLICATION

A claim for priority under 35 U.S.C. §119 is made to Korean Patent Application No. 10-2014-0172967, filed on Dec. 4, 2014, the entire contents of which are hereby incorporated by reference.

### BACKGROUND

The inventive concept relates to a wireless communication device, and more particularly, to a wireless communication device performing an authentication operation through a near field communication (NFC) function.

Radio-frequency identification (RFID) systems, which may be characterized as wireless frequency identification systems, create an automatic identification field using a radio wave such as an ultra shortwave or a long wave, to recognize predetermined information stored in advance. According to operation principles of RFID systems, a reader may obtain unique information of goods fitted with a tag, by receiving and analyzing information stored in the tag.

Because an RF signal is used, RFID systems typically are not affected by surrounding environment such as snow, rain, wind, dust and magnetic flux. RFID systems are capable of recognizing information with high recognition speed even when a tag is moving and are capable of recognizing information even from a long distance, and each tag is given a unique ID in the manufacturing process to be unforgeable.

RFID systems generally include a reader, an antenna and a tag. The antenna acts as a relay between the tag and the reader. The reader transmits power and a signal to the tag using a signal of a predetermined frequency to activate the tag, and receives a response from the activated tag.

Near field communication (NFC) is a category of RFID systems as provided in the International Organization of Standards (ISO) 18092 standards, and uses a frequency of 13.56 MHz and transmits data with low power over a short range. Signals of various frequencies such as 125 MHz, 135 MHz and 900 MHz can be used for NFC instead of 13.56 MHz.

NFC is capable of transmission and reception of data between information devices, and therefore address books, games, MP3 files, or the like may be exchanged between a notebook and portable terminals, as well as between portable terminals. NFC technology using a predetermined frequency band is highly stable and may thereby be used to enable mobile payment using a transportation card for example. By accessing tags storing predetermined information, NFC technology may be used in information terminals to obtain all sorts of information in the future.

It is predicted that in the near future, portable terminals for mobile communications, such as cellular phones for example, may be fitted with a chip for NFC is at an early stage of manufacture. Portable terminals fitted with a chip for NFC would include an NFC antenna, and would perform communication with an external reader through the NFC antenna.

### SUMMARY

Embodiments of the inventive concept provide a wireless communication device. The wireless communication device includes a terminal body including a near field communication (NFC) function; and accessories attachable to the terminal body. The accessories include a wireless authentication module configured to perform an authentication operation through wireless communication with the terminal body. Upon attachment of the accessories to the terminal body, the wireless authentication module is configured to perform the authentication operation using inductive coupling between an NFC coil of the terminal body and an authentication coil of the wireless authentication module, and at least a part of a side of a first coil of the authentication coil is located outside a side of a second coil of the NFC coil.

Embodiments of the inventive concept also provide a terminal cover built in a portable terminal, the portable terminal including a near field communication (NFC) function configured to perform a function set after an authentication operation with the terminal cover. The terminal cover includes a wireless authentication module configured to perform the authentication operation with the portable terminal. The wireless authentication module includes a parallel resonant circuit including a coil, a capacitor and a resistor; and a control circuit configured to control wireless communication with the portable terminal by changing a resonant frequency and quality factor of the parallel resonant circuit.

Embodiments of the inventive concept further provide a portable terminal that includes a terminal body including a first coil configured to perform near field communication (NFC); and an accessory detachably connected to the terminal body. The accessory includes a wireless authentication module configured to perform an authentication operation through NFC with the terminal body. The wireless authentication module includes a second coil configured to perform the NFC with the first coil, and a control circuit configured to change a resonant frequency of the second coil responsive to a state of the wireless authentication module.

### BRIEF DESCRIPTION OF THE FIGURES

Embodiments of the inventive concept will be described below in more detail with reference to the accompanying drawings. The embodiments of the inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 is a drawing illustrating a portable terminal including a wireless authentication module, according to an embodiment of the inventive concept.

FIG. 2 is a drawing explanatory of a near field communication (NFC) operation of a portable terminal in which a cover fitted with a wireless authentication module is combined with a terminal body.

FIGS. 3A and 3B are drawings illustrating, in the case that an NFC mode of a portable terminal is a card mode, a magnetic field generated depending on a location of an authentication coil with respect to an NFC coil.

FIGS. 4A through 4C are drawings illustrating available locations of an authentication coil and an NFC coil, according to embodiments of the inventive concept.

FIG. 5 is a drawing illustrating a wireless authentication module, according to an embodiment of the inventive concept.

FIGS. 6A and 6B are drawings illustrating frequency characteristics of an authentication coil during an authentication operation and during an uncertified operation, respectively.

FIG. 7 is a block diagram illustrating a portable terminal including a wireless authentication module, according to an embodiment of the inventive concept.

### DETAILED DESCRIPTION OF EMBODIMENTS

Embodiments of inventive concepts will be described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, etc. may be used herein to describe various elements, these elements should not be limited by these terms. These terms are only used to distinguish one element from another. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will also be understood that when an element such as a layer, region or substrate is referred to as being “on” or “onto” another element, it may lie directly on the other element or intervening elements or layers may also be present. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

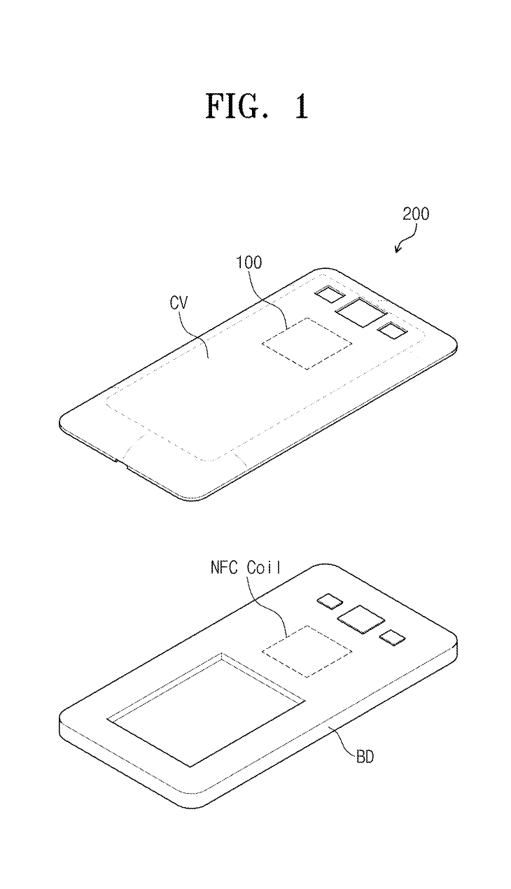

FIG. 1 is a drawing illustrating a portable terminal including a wireless authentication module, according to an embodiment of the inventive concept. Referring to FIG. 1, portable terminal 200 includes a terminal body BD, and a cover CV which can be attached to and detached from a back side of the terminal body BD. The terminal body BD includes an NFC coil for a near field communication (NFC). The cover CV includes a wireless authentication module 100. In the case that the terminal body BD is fitted with the cover CV, the terminal body BD can perform an authentication operation of the cover CV using the wireless authentication module 100 through the NFC coil.

Generally, a portable terminal such as a cellular phone, a tablet PC, or the like, is provided with original accessories by the manufacturing company, the original accessories capable of performing additional functions. The original accessories may be built in the terminal body BD to perform a function set. For example, in the case that the accessory is a flip cover, the accessory may perform turning on or turning off the screen of the wireless communication device. For example, in the case that an accessory is an audio playing device, the accessory may control a function of a docking station, such as playing, pausing, forwarding, or stopping when the wireless communication device is docked in the docking station. In the case that original accessories are built in the terminal body BD, the terminal body BD can check whether the built-in accessories are original or not. That is, an authentication operation may be performed between the accessories and the terminal body BD. The wireless authentication module 100 may be built in the accessories described above. The accessories with built-in wireless authentication module 100 may be built in the terminal body BD to perform an authentication operation with respect to the terminal body BD.

In the case that the wireless authentication module 100 is built in an accessory such as the cover CV, its location has to be a location that can perform an NFC with the NFC coil located at the terminal body BD. In the case that the cover CV is built on the terminal body BD, it is best that a coil included in the wireless authentication module 100 is located inside the NFC coil of the terminal body BD. In this case, the greatest electro motive force is induced in the coil included in the wireless authentication module 100, and a communication with the terminal body BD may be smoothly performed. Only from the viewpoint of such an authentication operation, it is desirable that an authentication coil of the wireless authentication module 100 is located inside the NFC coil of the terminal body BD. However, in a reader mode or a card mode, the NFC coil of the terminal body BD may perform an NFC (near field communication) with a coil of an external device. In this case, a problem may occur in an NFC between the terminal body BD and the external device depending on a location of the wireless authentication module 100.

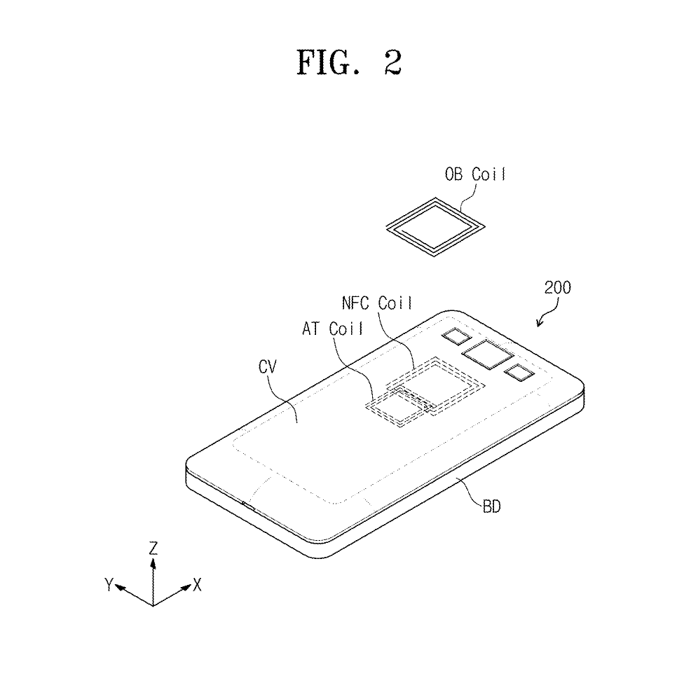

FIG. 2 is a drawing explanatory of a near field communication (NFC) operation of a portable terminal on which a cover fitted with a wireless authentication module is combined with a terminal body. Referring to FIG. 2, portable terminal 200 includes a terminal body BD and a cover CV built on a back side of the terminal body BD. The portable terminal 200 may perform an authentication operation of a wireless authentication module by a mutual induction action between an authentication coil (AT coil) of the wireless authentication module and an NFC coil of the terminal body BD.

The wireless authentication module 100 in accordance with the inventive concept may be built on the cover CV. In the case that the cover CV is built on the terminal body BD, an NFC module of the terminal body BD may be set in a reader mode to generate a magnetic field through the NFC coil. The terminal body BD can perform a communication with the wireless authentication module 100, using the magnetic field generated by the NFC coil. The terminal body BD judges whether the built-in cover CV is an authenticated cover through the communication described above. The authentication operation may be performed only once when the cover CV is built on the terminal body BD, or may be repeatedly performed after each of a plurality of set periods. In the case that this authentication operation is completed, the wireless authentication module 100 is deactivated and an NFC may be performed between the NFC coil of the terminal body BD and an object coil (OB coil) of an external device.

The object coil may be a coil that may exist in an external device capable of performing an NFC with the portable terminal 200. The external device may be different depending on whether the NFC mode of the portable terminal 200 is a card mode or a reader mode. For example, in the case that the NFC mode of the portable terminal is a card mode, the external device may be a terminal installed in public transportation to collect payment of fare. For example, in the case that the NFC mode of the portable terminal is a reader mode, the external device may be a device of a card type for transmitting specific information to the portable terminal through NFC.

When the NFC mode of the portable terminal 200 operates in a card mode or a reader mode, the object coil of the external device is located on a Z axis of the NFC coil. In the case that the object coil and the NFC coil are located within a distance from each other at which communication is possible, the portable terminal 200 may exchange information with the external device according to the mode described above.

As described above, in the case that an authentication operation is performed on the terminal body BD and the cover CV fitted with the wireless authentication module 100, it is desirable that the authentication coil is located inside the NFC coil. In this case, the authentication coil can be supplied with the largest electric power from the NFC coil and thereby a communication for an authentication operation may be smoothly performed.

From the viewpoint of an authentication of the cover CV, it is desirable that the authentication coil is located inside the NFC coil. However, this relative location between the authentication coil and the NFC coil may cause a problem when the portable terminal 200 performs an NFC with an external device. This is because as described above, although the wireless authentication module 100 may be deactivated after an authentication operation, a current may still flow through the authentication coil according to an induced electromotive force.

In the case that the NFC mode of the portable terminal 200 is a reader mode, and in the event that current may flow through the authentication coil when deactivated according to an induced electromotive force as described above, resonant frequencies of the NFC coil of portable terminal 200 and the object coil of the external device, when the portable terminal 200 performs an NFC with the external device, may not match. This reduces an output of the NFC coil which operates as a reader. Thus, a communication with the external device may not be smoothly performed. If the portable terminal 200 is controlled in a reader mode to optimize resonance matching with the external device, this phenomenon may be solved.

Moreover, in the case that the NFC mode of the portable terminal 200 is a card mode, a serious problem may occur in a communication with the external device. This is because a current of the NFC coil induced by the object coil of the external device and a current of the authentication coil may become a level enough to compare with each other, and thereby a phenomenon that a resonant frequency of the NFC coil of the portable terminal 200 is lowered may occur. Because of such a frequency reduction, a range of an NFC in a card mode of the portable terminal 200 may be reduced.

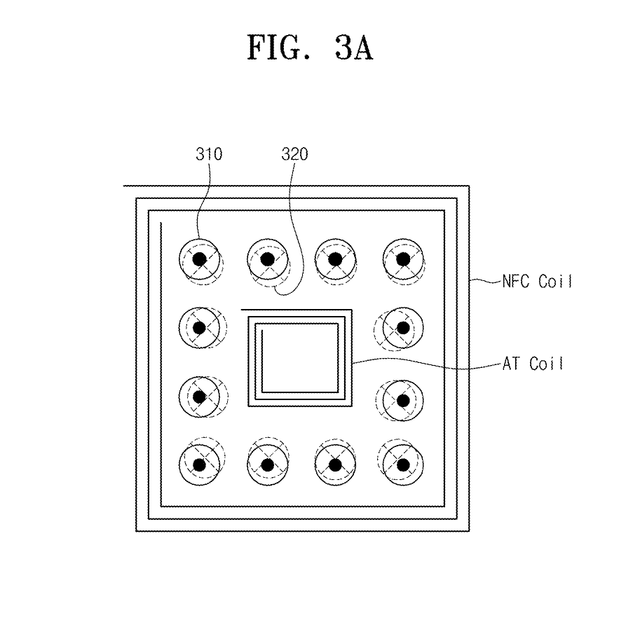

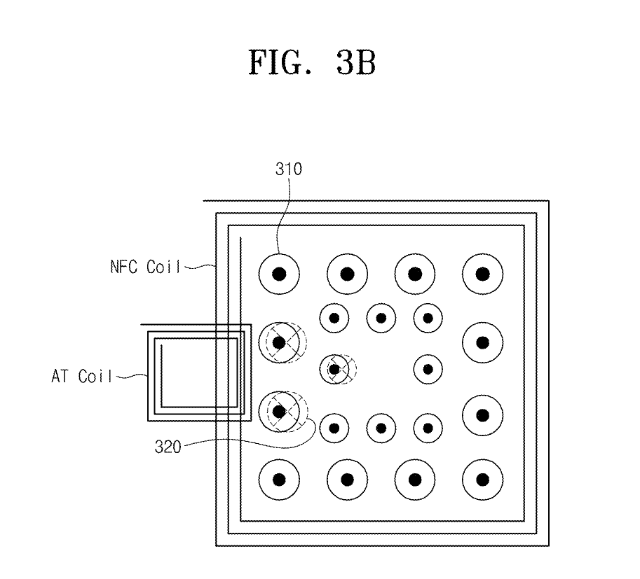

FIGS. 3A and 3B are drawings illustrating, in the case that an NFC mode of a portable terminal is a card mode, a magnetic field generated depending on a location of an authentication coil with respect to an NFC coil. Referring to FIGS. 3A through 3B, a mutual influence of a magnetic field generated depending on a location of the authentication coil (AT coil) of the wireless authentication module 100 with respect to the NFC coil of the terminal body BD can be checked.

FIG. 3A illustrates a magnetic field generated when the authentication coil is located inside the NFC coil. An upward magnetic field is generated at the area inside the NFC coil by the object coil (OB coil) of the external device, as indicated by the solid circles 310. A downward magnetic field is generated at the area outside the authentication coil by the object coil of the external device, as indicated by the dashed circles 320. That is, a direction of the magnetic field generated at the area inside the NFC coil is opposite to a direction of the magnetic field generated at the area outside the authentication coil. Thus, a considerable amount of the magnetic field generated at the area inside the NFC coil is offset by the magnetic field generated by the authentication coil. In the case that the magnetic field generated at the area inside the NFC coil is offset, a communication between the portable terminal 200 and the external device is not smoothly performed. That is, the external device does not well recognize the portable terminal as a card.

FIG. 3B illustrates a magnetic field generated when a part of the authentication coil (AT coil) overlaps the NFC coil. An upward magnetic field is generated at the area inside the NFC coil by the object coil (OB coil) of the external device, as indicated by the solid circles 310. A downward magnetic field is generated at the area outside the authentication coil by the object coil of the external device, as indicated by the dashed circles 320. In the case of FIG. 3B, since a part of the authentication coil overlaps the NFC coil, the effect of the magnetic field generated by the authentication coil on the magnetic field generated by the NFC coil is reduced. That is, only a part of the magnetic field at the area inside the NFC coil is offset by the magnetic field generated by the authentication coil. In other words, since the magnetic field at the area inside the NFC coil is not entirely or mostly offset by the magnetic field generated by the authentication coil, a communication between the portable terminal 200 and the external device may be performed. That is, the external device can well recognize the portable device as a card.

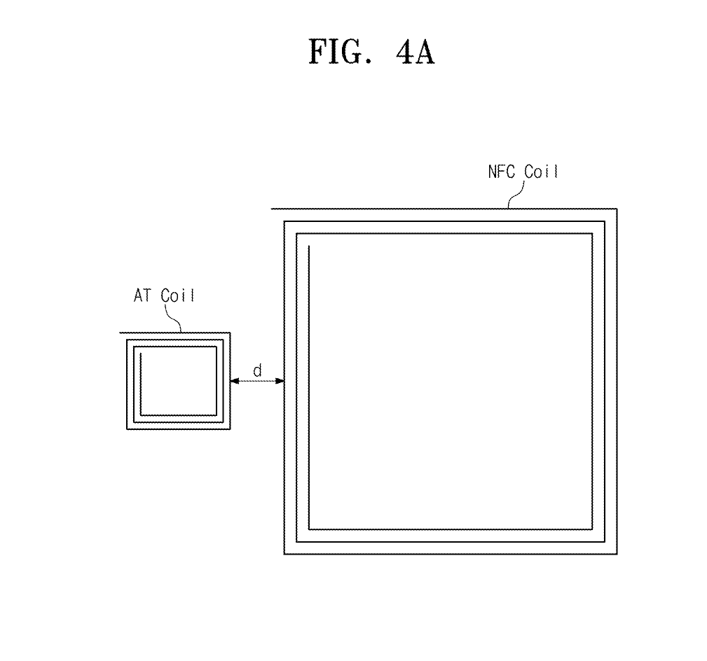

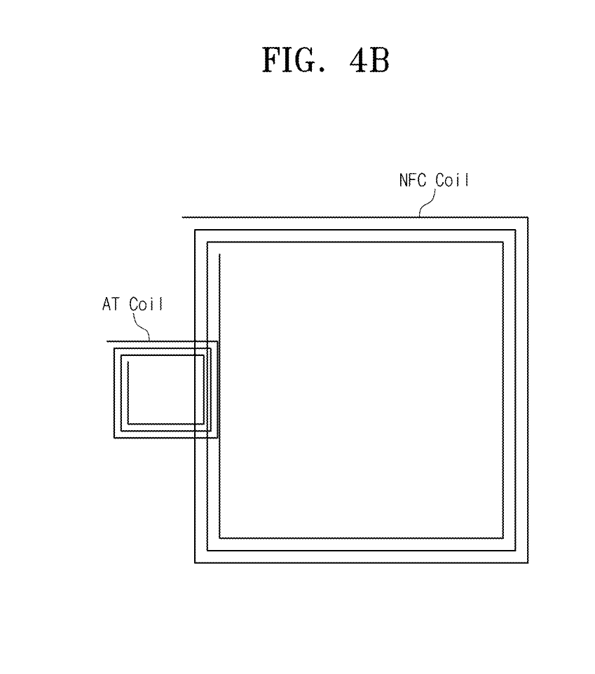

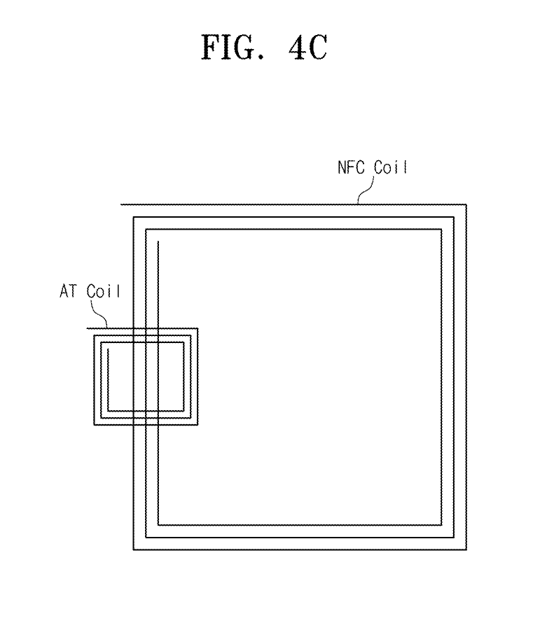

FIGS. 4A through 4C are drawings illustrating available locations of an authentication coil and an NFC coil, according to embodiments of the inventive concept. In FIGS. 4A through 4C, the authentication coil (AT coil) may be located inside the wireless authentication module 100 of the cover CV described above, and the NFC coil may be located inside the terminal body BD. In the case that the cover CV is built on the terminal body BD, the authentication coil and the NFC coil are located on the same plane but are not directly in contact with each other. In this case, a distance between the authentication coil and the NFC coil may be limited to a distance at which the authentication operation is possible, that is, the authentication coil can communicate with the NFC coil. In the case of the authentication operation, since a comparatively strong magnetic field is generated through the NFC coil, some margin may exist in a distance between the authentication coil and the NFC coil.

FIG. 4A illustrates a case that the authentication coil does not overlap the NFC coil. A distance (d) between the authentication coil and the NFC coil can be changed within a distance at which a communication between the authentication coil and the NFC coil is possible. In an authentication operation between the authentication coil and the NFC coil, since a magnetic field generated in the NFC coil is comparatively strong, a communication between the authentication coil and the NFC coil is possible even if the authentication coil does not overlap the NFC coil.

FIG. 4B illustrates a case that one side of the authentication coil overlaps one side of the NFC coil. In FIG. 4B, the effect of the magnetic field generated by the authentication coil on the magnetic field generated by the NFC coil is comparatively small. Thus, the authentication operation between the authentication coil and the NFC coil can be smoothly performed.

FIG. 4C illustrates a case that a part of the authentication coil overlaps an area inside the NFC coil. In this case, the effect of the magnetic field generated by the authentication coil on the magnetic field generated by the NFC coil is greater than compared with the cases of FIGS. 4A and 4B. However, even in the case of FIG. 4C, unlike the case of FIG. 3A, the effect by the magnetic field generated by the authentication coil is not great enough to make it difficult for the portable terminal to communicate with the external device in a card mode. That is, even if the magnetic field generated by the authentication coil offsets a part of the magnetic field generated by the NFC coil, the effect is not great enough to disturb an NFC (near field communication) between the portable terminal and the external device.

In the case of FIGS. 4A through 4C, from the viewpoint of the authentication operation, in the case of FIG. 4C, the strongest magnetic field occurs between the authentication coil and the NFC coil and thereby the authentication operation can be most smoothly performed. However, from the viewpoint that the portable terminal performs an NFC with the external device in a card mode, in the case of FIG. 4A, the effect of the magnetic field generated by the authentication coil on the magnetic field generated by the NFC coil is smallest. Thus, it would be advantageous that the cover CV and the wireless authentication module 100 are disposed so that the authentication coil and the NFC coil are located such as shown FIG. 4A.

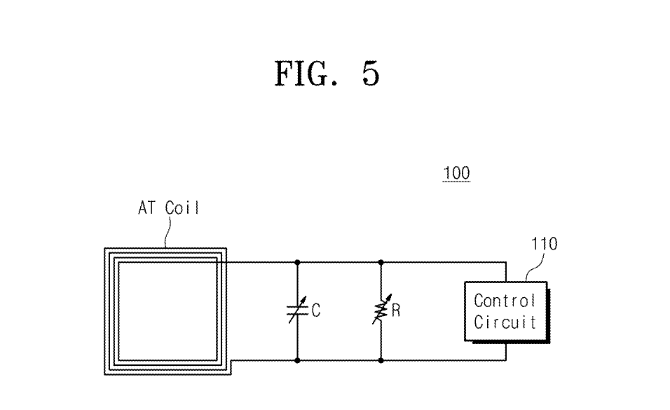

FIG. 5 is a drawing illustrating a wireless authentication module, according to an embodiment of the inventive concept. Referring to FIG. 5, the wireless authentication module 100 includes an authentication coil (AT coil), a capacitor (C), a resistor (R) and a control circuit 110. The wireless authentication module 100 is installed on the cover CV, and in the case that the cover CV is combined with the terminal body BD, the wireless authentication module 100 performs an authentication operation through a communication with the NFC coil of the terminal body BD. The authentication operation may be an operation checking whether the cover CV is an original product provided by a terminal manufacturing company.

The authentication coil, the capacitor (C) and the resistor (R) are connected in parallel to form a parallel resonance circuit. Capacitance of the capacitor (C) and a resistance level of the resistor (R) may be controlled by the control circuit 110. For example, in the case that a communication in accordance with an authentication operation between the authentication coil and the NFC coil has to be performed, the control circuit 110 may control capacitance of the capacitor (C) and a resistance level of the resistor (R), so that a resonance frequency of the authentication coil becomes the same as a resonance frequency of the NFC coil. In the case that the authentication operation is finished, it may be desirable that the effect on the authentication coil by controlling capacitance and resistance level as noted above be removed if possible. Thus, the control circuit 110 may control capacitance of the capacitor (C) and a resistance level of the resistor (R) so that a resonance frequency of the authentication coil becomes different from a resonance frequency of the NFC coil.

The control circuit 110 may change a quality factor (Q) of the parallel resonant circuit. The quality factor (Q) of the parallel resonant circuit may be changed by controlling capacitance of the capacitor (C) and a resistance level of the resistor (R).

In the case that a communication in accordance with an authentication operation between the authentication coil and the NFC coil has to be performed, the control circuit 110 may control capacitance of the capacitor (C) and a resistance level of the resistor (R), so that the quality factor (Q) of the parallel resonant circuit has a high value. In this case, power transmitted from a resonance frequency of the parallel resonant circuit increases and thereby the authentication operation may be better performed. In the case that authentication operation is finished, it may be desirable that the effect on the authentication coil by controlling capacitance and resistance level as noted above be removed if possible. The control circuit 110 may control capacitance of the capacitor (C) and a resistance level of the resistor (R) so that the quality factor (Q) of the parallel resonant circuit has a low value. In this case, power transmitted from a resonance frequency of the parallel resonant circuit is reduced and thereby an effect by the magnetic field generated by the authentication coil may be reduced.

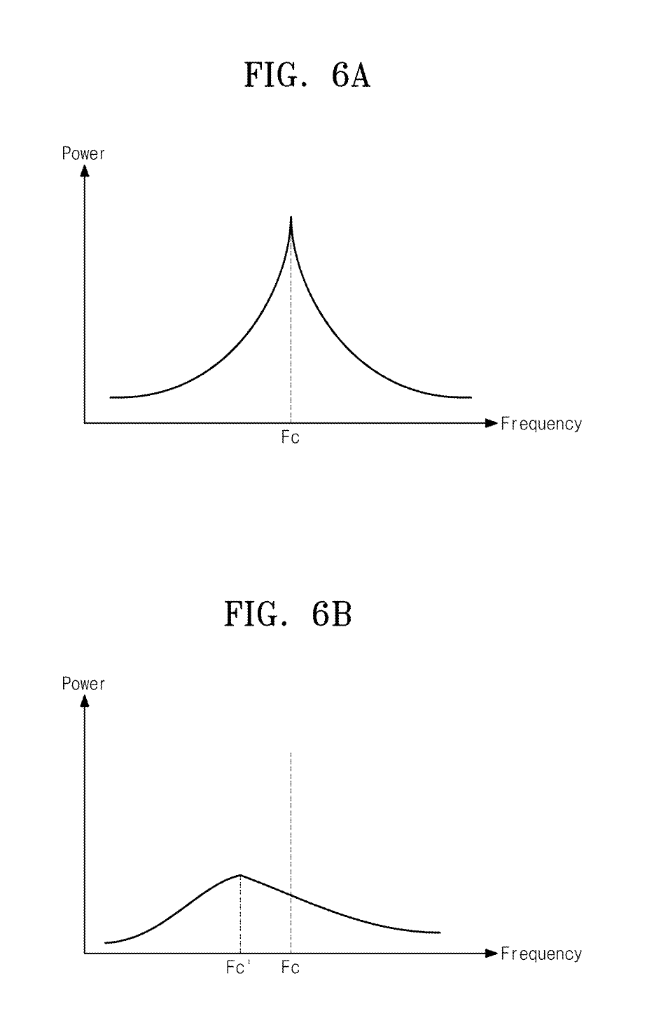

FIGS. 6A and 6B are drawings illustrating frequency characteristics of an authentication coil during an authentication operation and during an uncertified operation, respectively. The horizontal axes in FIGS. 6A and 6B represent frequency of the authentication coil, and the vertical axes represent power transmitted by the authentication coil. FIG. 6A illustrates a frequency characteristic during an authentication operation, and FIG. 6B illustrates a frequency characteristic during an uncertified operation.

In the case of FIG. 6A, it can be checked and appreciated that a resonant frequency (Fc) of the authentication coil coincides with a resonant frequency (Fc) of the NFC coil. It can also be appreciated that the quality factor (Q) of the authentication coil has a high value compared with FIG. 6B, whereby power transmitted from the resonant frequency (Fc) is greater. Thus, during the authentication operation, a communication between the authentication coil and the NFC coil can be more smoothly performed.

In the case of FIG. 6B, it can be checked and appreciated that a resonant frequency (Fc′) of the authentication coil is different from a resonant frequency (Fc) of the NFC coil. That is, it can be checked that resonant frequencies of the authentication coil and the NFC do not match. It can also be checked that the quality factor (Q) has a low value compared with FIG. 6A, whereby power transmitted from the resonant frequency (Fc′) of the authentication coil is smaller. Thus, during an unauthorized operation, an effect of the magnetic field generated by the authentication coil on the NFC coil may be reduced. During an unauthorized operation, it may be desirable that NFC with the authentication coil can not occur or is at least practically difficult. The inventive concept can minimize the effect by controlling the resonant frequency and the quality factor (Q). The resonant frequency and the quality factor (Q) may be individually or concurrently controlled.

As described above, an operation of the wireless authentication module can be optimized by properly changing the resonant frequency and the quality factor (Q) according to a state of the wireless authentication module.

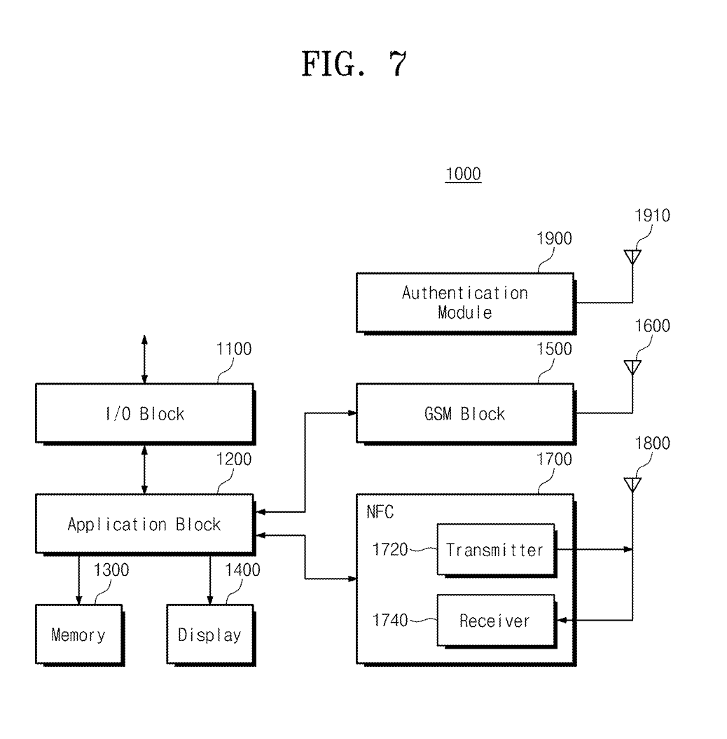

FIG. 7 is a block diagram illustrating a portable terminal including a wireless authentication module, according to an embodiment of the inventive concept. The device illustrated in FIG. 7 may be a mobile phone. However, in other embodiments of the inventive concept, a device other than a mobile phone may be realized.

Referring to FIG. 7, a portable terminal 1000 includes an input/output block 1100, an application block 1200, a memory 1300, a display 1400, a global system for mobile communication (GSM) block 1500, a near field communication (NFC) transmitter/receiver 1700 and a wireless authentication module 1900. The portable terminal 1000 also includes an antenna 1600 for communication through the GSM (global system for mobile communication) block 1500, an antenna 1800 for NFC communication through the NFC transmitter/receiver 1700 and an antenna 1910 for wireless authentication operation of the wireless authentication module 1900. The constituent elements or blocks of the portable terminal 1000 of FIG. 7 are only illustrative. The portable terminal 1000 may include more constituent elements or blocks or less constituent elements or blocks. It is illustrated that the portable terminal 1000 uses a GSM technology, but the portable terminal 1000 may however be embodied using other technologies such as a CDMA (code division multiple access). The blocks of FIG. 7 may be embodied in integrated circuit form. However, some of the blocks may be embodied in integrated circuit form, but some other blocks may be embodied in another form.

The GSM block 1500 is connected to the antenna 1600 and operates to provide wireless telephone operations in a well known manner. The GSM block 1500 internally includes a receiver (not shown) and a transmitter (not shown) to perform corresponding receiving and transmitting operations.

The NFC transmitter/receiver 1700 performs wireless communication using inductive coupling, and includes a transmitter 1720 and a receiver 1740. The transmitter 1720 of the NFC transmitter/receiver 1700 provides NFC signals to the antennal 1800, and the antenna 1800 transmits NFC signals through inductive coupling. The antenna 1800 receives NFC signals (provided from another NFC device) and provides the received NFC signals to the receiver 1740.

The NFC transmitter/receiver 1700 operates according to regulations described in an NFC interface/a protocol-1 (NFCIP-1) and an NFC interface/a protocol-2 (NFCIP-2) and standardized in ECMA-340, ISO/IEC 18092, ETSI TS 102 190, ISO 21481, ECMA 352, ETSI TS 102 312, and the like.

The application block 1200 includes hardware circuits (for example, one or more processors) and operates to provide various user applications provided by the portable terminal 1000. The user applications may include voice call operations, data transmission, or the like. The application block 1200 operates together with the GSM block 1700 and provides those characteristics.

The display 1400 displays an image in response to display signals received from the application block 1200. The image may be generated by a camera (not shown) provided to the portable terminal 1000. The display 1400 may internally include a memory (for example, a frame buffer) to temporarily store pixel values, and may be constituted by a liquid crystal display screen together with related control circuits. The input/output block 1100 provides an input function to a user and provides outputs to be received through the application block 1200.

The memory 1300 stores programs (commands) to be used by the application block 1200 and/or data, and may be embodied by a RAM, a ROM, a flash memory, or the like. Thus, the memory 1300 may include not only volatile storage devices but also nonvolatile storage devices.

The antenna 1800 communicates with external antennas through inductive coupling and may be used to transmit and receive NFC signals. The antenna 1800 may have a coil form.

The wireless authentication module 1900 may perform a wireless-communication with the NFC transmitter/receiver 1700 through the antenna 1910. The antenna 1910 may have a coil form. That is, the antenna 1800 may be the NFC coil and the antenna 1910 may be the authentication coil as previously described. The wireless authentication module 1900 may be installed in accessories that may be built in the portable terminal 1000. In the case that accessories are built in the portable terminal 1000, the wireless authentication module 1900 may perform an authentication operation through the antenna 1910. In this case, locations of the antenna 1910 and the antenna 1800 may be one of dispositions illustrated in FIGS. 4A through 4C, however the locations are not limited thereto. Various dispositions are possible, except for a disposition that the antenna 1910 is located inside the antenna 1800.

According to some embodiments of the inventive concept, an authentication operation of accessories being built in a portable terminal can be wirelessly performed, and thereby there is no need to form a separate contact terminal in a wireless communication device. Thus, price competitiveness of the portable terminal can be improved.

According to some embodiments of the inventive concept, an effect on an NFC function of the portable terminal due to addition of an authentication coil for an authentication operation can be minimized.

What is claimed is:

1. A wireless communication device comprising:
a terminal body comprising a near field communication (NFC) function; and
accessories attachable to the terminal body, the accessories include a wireless authentication module configured to perform an authentication operation through wireless communication with the terminal body,
wherein upon attachment of the accessories to the terminal body, the wireless authentication module is configured to perform the authentication operation using inductive coupling between an NFC coil of the terminal body and an authentication coil of the wireless authentication module, and at least a part of a side of a first coil of the authentication coil is located outside a side of a second coil of the NFC coil.

2. The wireless communication device of claim 1, wherein the wireless authentication module is configured to be activated when the authentication operation is performed on the terminal body and deactivated after the authentication operation.

3. The wireless communication device of claim 2, wherein the authentication operation is performed after each of a plurality of set periods.

4. The wireless communication device of claim 1, wherein the wireless authentication module comprises the authentication coil, a capacitor, a resistor and a control circuit,
wherein the control circuit is configured to control a capacitance of the capacitor and a resistance level of the resistor depending on an activation or deactivation state of the wireless authentication module.

5. The wireless communication device of claim 4, wherein the authentication coil, the capacitor and the resistor are connected in parallel as a parallel resonant circuit.

6. The wireless communication device of claim 5, wherein during the activation state, the control circuit is configured to control the capacitance of the capacitor and the resistance level of the resistor to match a resonant frequency of the parallel resonant circuit with a resonant frequency of the NFC coil.

7. The wireless communication device of claim 5, wherein during the activation state, the control circuit is configured to control the capacitance of the capacitor and the resistance level of the resistor to increase a quality factor value of the parallel resonant circuit.

8. The wireless communication device of claim 5, wherein during the deactivation state, the control circuit is configured to control the capacitance of the capacitor and the resistance level of the resistor to make a resonant frequency of the parallel resonant circuit different than a resonant frequency of the NFC coil.

9. The wireless communication device of claim 5, wherein during the deactivation state, the control circuit is configured to control the capacitance of the capacitor and the resistance level of the resistor to decrease a quality factor value of the parallel resonant circuit.

10. A terminal cover built in a portable terminal, the portable terminal including a near field communication (NFC) function configured to perform a function set after an authentication operation with the terminal cover, the terminal cover comprising:
a wireless authentication module configured to perform the authentication operation with the portable terminal,
wherein the wireless authentication module comprises
a parallel resonant circuit comprising a coil, a capacitor and a resistor; and
a control circuit configured to control wireless communication with the portable terminal by changing a resonant frequency and quality factor of the parallel resonant circuit.

11. The terminal cover of claim 10, wherein the wireless authentication module comprises an authentication coil and the portable terminal comprises an NFC coil, and
at least a part of a side of a first coil of the authentication coil is located outside a side of a second coil of the NFC coil.

12. The terminal cover of claim 11, wherein the wireless authentication module is configured to be activated when the authentication operation is performed on the portable terminal and deactivated after the authentication operation.

13. The terminal cover of claim 12, wherein during the activated state, the control circuit is configured to control a capacitance of the capacitor and a resistance level of the resistor to match a resonant frequency of the parallel resonant circuit with a resonant frequency of the NFC coil.

14. The wireless communication device of claim 12, wherein during the deactivated state, the control circuit is configured to control a capacitance of the capacitor and a resistance level of the resistor to make a resonant frequency of the parallel resonant circuit different than a resonant frequency of the NFC coil.

15. The wireless communication device of claim 14, wherein during the deactivated state, the control circuit is configured to control the capacitance of the capacitor and the resistance level of the resistor to decrease a quality factor value of the parallel resonant circuit.

16. A portable terminal comprising:
a terminal body comprising a first coil configured to perform near field communication (NFC); and
an accessory detachably connected to the terminal body, the accessory comprising a wireless authentication module configured to perform an authentication operation through NFC with the terminal body, the wireless authentication module comprising a second coil configured to perform the NFC with the first coil, and a control circuit configured to change a resonant frequency of the second coil responsive to a state of the wireless authentication module.

17. The portable terminal of claim 16, wherein the wireless authentication module is configured to be in an activated state when the authentication operation is performed and in a deactivated state after the authentication operation.

18. The portable terminal of claim 17, wherein the wireless authentication module comprises the second coil, a capacitor and a resistor configured as a parallel resonant circuit, and wherein the control circuit is configured to control a capacitance of the capacitor and a resistance level of the resistor based on whether the wireless authentication module is in the activation state or the deactivation state.

19. The portable terminal of claim 16, wherein upon connection of the accessory to the terminal body, at least a part of a side of the first coil is located outside a side of the second coil.

20. The portable terminal of claim 16, wherein the accessory comprises a terminal cover.
